(19) United States
(12) Patent Application Publication
(10) Pub. No.: US 2014/0182063 A1
(43) Pub. Date: Jul. 3, 2014

(54) Enhanced Thermally-Conductive Cushioning Foams by Addition of Graphite

(71) Applicant: Peterson Chemical Technology, Inc., Fort Smith, AR (US)

(72) Inventors: MARK L. CRAWFORD, Rudy, AR (US); Bruce W. Peterson, Fort Smith, AR (US); Matthew D. Mcknight, Fort Smith, AR (US)

(73) Assignee: Peterson Chemical Technology, Inc., Fort Smith, AR (US)

(21) Appl. No.: 14/135,188

(22) Filed: Dec. 19, 2013

Related U.S. Application Data
(60) Provisional application No. 61/746,359, filed on Dec. 27, 2012.

(51) Int. Cl. C09K 5/14

(52) U.S. Cl. CPC C09K 5/14
USPC 5/636; 5/740; 5/691; 252/75; 428/131; 428/174; 428/141; 428/317.9

(57) ABSTRACT

Methods and combinations for making and using one or more graphite enhanced thermally-conductive foam (TC Foam) layers located on, under, or in cushioning foams and mattresses. Enhanced thermally conductive foam layers may be placed between on, under, within, or between other layering substrates to increase the overall cooling capability of the composite. TC Foam may be used in mattresses, mattress topper pads, pillows, bedding products, medical cushioning foams, and similar materials used in bedding applications.

### CROSS-REFERENCE TO RELATED APPLICATION

This application claims the benefit of U.S. Provisional Patent Application No. 61/746,359, filed Dec. 27, 2012, incorporated herein in its entirety by reference.

### TECHNICAL FIELD

This invention relates to methods for making and using thermally conductive foam layers located on, under, or in mattresses and bedding products. This invention more specifically relates to mattresses, pillows, mattress topper pads, quilted toppers, medical mattresses and other bedding products having thermally conductive foam layers containing graphite.

### TECHNICAL BACKGROUND

Foams such as open-celled polyurethane flexible foams, close-celled polyurethane flexible foams, latex foams and melamine foams typically have low thermal conductivities in the range of 0.035-0.060 W/(m K). Materials with low thermal conductivities typically function as insulators, such a rigid polyurethane foam insulation board or expanded polystyrene insulation boards used for insulating purposes.

Heat transfer consists of a combination of conduction, convection and radiation. In a cushion or mattress, heat transfer by radiation is not very large. Instead, heat transfer by conduction and convection are the primary paths for moving heat in a cushion or mattress. As a person sleeps on a mattress, the compressed foam underneath the body has reduced air flow paths, and the primary mode for heat flow in the region below the body is conduction.

Heat is conducted from the body, through the compressed foam and dispersed into cushion or mattress regions where the foam is not compressed as much, which allows natural convection to occur more readily to remove heat from the mattress. Due to the low thermal conductivity of foam, this process is slow and requires a large temperature gradient to drive the conduction of heat at a rate similar to the heat production in a person's body. This results in a large region of hot foam around the body making the foam uncomfortable.

### SUMMARY

There is provided, in one non-limiting form, methods of forming an enhanced thermally-conductive graphite-containing foam (referred as “TC Foam” or thermally-conductive foam) comprised of a flexible cellular foam and a graphite material. Flexible cellular foams may include, but are not limited to, open cell polyurethane foam, partially open cell polyurethane foam, open cell polyester polyurethane foam, partially open cell polyester polyurethane foam, latex foam, melamine foam, and combinations thereof. Phase change materials, colorants, plasticizers or other performance modifying additives may optionally be incorporated into the TC Foam. The TC Foam contains a graphite material in the range of about 0.1% to about 75% by weight based on the final foam net weight after gas loss. “Gas loss” or “solvent loss” simply means the remaining weight after removal of substantially all of the solvent by evaporation, absorption, or other technique. Generally, the TC Foam has enhanced or improved conductivity as compared to an otherwise identical foam absent the graphite. TC Foam may be used in articles of manufacture including, but not necessarily limited to, medical cushioning foams, mattresses, pillows, bedding products, mattress topper pads, mattress pillow toppers, quilted mattress toppers, and combinations thereof.

The graphite material may be selected from the following non-limiting list of functional materials: natural flake graphite, powder graphite, graphene sheets, graphene, synthetic graphite, graphite-based particulates, and combinations thereof.

The TC Foam may be cut or molded in many structures such as, but not limited to, planar layers, convoluted layers, surface modified layers, 2D or 3D surface texturing, molded pillows, smooth molded surfaces, molded surfaces with regular or irregular patterns, or modified in any way as to generate a desired physical structure such as, but not limited to, hole punching, channeling, reticulation or other method known to the art of foaming for modifying the structure of foam. The TC Foam may be adhered in the cushion or mattress composite with adhesive or melting of a thermoplastic on the foam surface and allowing the thermoplastic to re-solidify and lock the TC Foam in place on the substrate foam. The TC Foam may also be made using known free-rise methods and techniques.

There is also provided, in a non-restrictive embodiment, combinations of suitable layering substrates including, but not limiting to, flexible polyurethane foam, latex foam, flexible melamine foam, and other substrates (such as fibers in woven or non-woven form) with one or more TC Foams. Articles that may be manufactured from these combinations of one or more TC Foams substrates include, but are not necessarily limited to, mattresses, mattress topper pads, pillows, bedding products, pet beds, quilted mattress toppers, pillow or mattress inserts, contoured support foam or other like materials commonly used in the bedding environment, and combinations thereof.

### BRIEF DESCRIPTION OF THE DRAWINGS

FIG. 1 is an illustration of a possible heat transfer pathway in a mattress cross section;

FIG. 2 is an example construction using a cushion and/or mattress application;

FIG. 3 is an example construction using a cushion and/or mattress application;

FIG. 4 is an example construction using a cushion and/or mattress application;

FIG. 5 is an example construction using a cushion and/or mattress application;

FIG. 6 is an example construction using a cushion and/or mattress application;

FIG. 7 is an example construction using a cushion and/or mattress application;

FIG. 8 is an example construction using a cushion and/or mattress application;

FIG. 9 is an example construction using a cushion and/or mattress application;

FIG. 10 is an example construction using a cushion and/or mattress application;

FIG. 11 is an example breakdown of lateral mattress zones in a cushion and/or mattress application;

FIG. 12 is an example breakdown of longitudinal mattress zones in a cushion and/or mattress application;

FIG. 13 is an example of a molded pillow product where the entire structure is molded from TC Foam;

FIG. 14 is an example of a molded pillow product where the TC Foam is a region or layer within the pillow;

FIG. 15 is an example of a wheelchair seat using TC Foam in its construction;

FIG. 16 is a graph of thermal conductivity expressed as temperature over time for 3.1 pound/ft³ (pcf) graphite-infused viscoelastic foam compared to 1.7 pcf conventional soft memory foam and 5.3 pcf conventional memory foam;

FIG. 17 is a schematic illustration of uncompressed viscoelastic (visco) foam;

FIG. 18 is a schematic illustration of compressed visco foam;

FIG. 19 is a schematic illustration of uncompressed, graphite-infused visco foam;

FIG. 20 is a schematic illustration of compressed, graphite-infused visco foam; and

FIG. 21 is a graph showing static thermal conductivity of two different types of graphite-infused visco foams in comparison to a control foam.

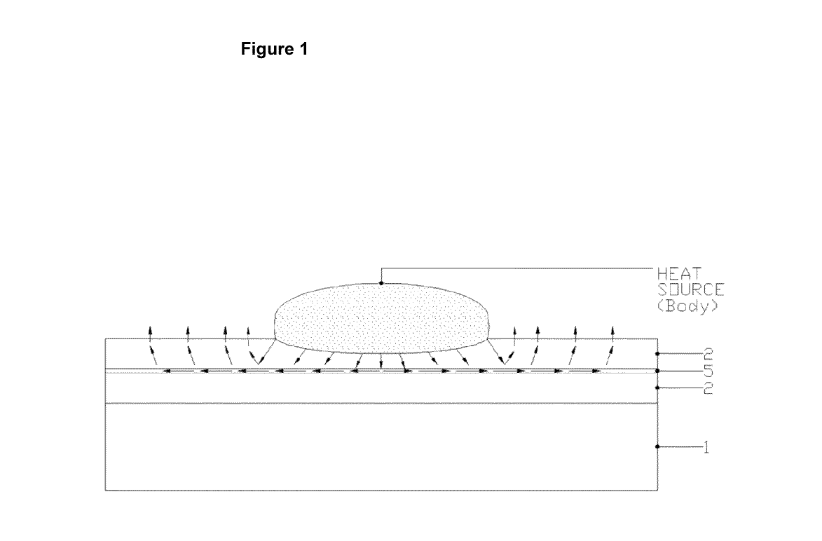

It will be appreciated that FIGS. 1-15 and 17-20 are schematic and that the various elements are not necessarily to scale or proportion, and that many details have been removed or simplified for clarity, and thus the invention is not necessarily limited to the embodiments depicted in the Figures.

Before the invention is explained in detail, it is to be understood that the invention is not limited in applications to the details of construction and the arrangements of the components set forth in the following description or illustrated in drawings. Also, it is understood that the phraseology and terminology used herein are for the purpose of description and should not be regarded as limiting.

### DETAILED DESCRIPTION

It is useful to develop improved heat transfer in a mattress or bedding to provide cooler and more comfortable sleep or contact by incorporating a graphite material into a flexible cellular foam to be used on, under, or within a mattress or bedding. This material, a TC Foam, will exhibit higher or enhanced heat transfer properties due to possessing higher thermal conductivity created by the addition of graphite to flexible cellular foam.

Flexible cellular foams may include, but are not limited to, open-celled polyurethane foam, partially open-celled polyurethane foam, open-celled polyester polyurethane foam, partially open-celled polyester polyurethane foam, latex foam, melamine foam, and combinations thereof.

Heat transfer consists of a combination of conduction, convection and radiation. In a mattress or bedding, heat transfer by radiation is not very large. Instead, heat transfer by conduction and convection are the primary paths for moving heat in a mattress or bedding. As a person sleeps on a mattress, the compressed foam underneath the body has reduced air flow paths, and the primary mode of heat flow in the region below the body is conduction. Heat is conducted from the body, through the compressed foam, into mattress or bedding regions where the foam is not compressed as much, which allows natural convection to occur more readily to remove heat from the mattress. A cooler and more comfortable sleep may be obtained by increasing the thermal conductivity of a mattress or bedding and allowing the heat from the body to migrate away more rapidly.

Enhanced heat transfer reduces the amount of a temperature gradient that is required to generate a given amount of heat flow. This means that for the same amount of body heat, a mattress or bedding with graphite enhanced thermal conductivity will be able to have a lower surface temperature of the foam in contact with a person, while still conducting the heat away, resulting in cooler sleep.

FIG. 1 is a general representation of a heat transfer path when a person sleeps on a mattress with TC Foam located below the first layer of foam. However, FIG. 1 does not represent all the possible combinations of TC Foams and substrate foams.

It is useful to develop improved heat transfer in a cushion or mattress to provide cooler and more comfortable sleep by the addition of highly thermally conductive material graphite or alternatively graphene. With thermal conductivities in the range of 4,000-5,000 W/(m K), graphene layers have about 100,000 times the thermal conductivity of foam. Graphite may be understood as a material made of layers of graphene. Graphite exhibits thermal conductivities in the direction parallel to the graphene layers of about 140-500 W/(m K). In the direction perpendicular to the layers the thermal conductivity is lower, on the order of 3-10 W/(m K).

Expandable graphite, or intercalated graphite, is a form of graphite that has been treated with chemicals that cause separation of the graphene layers and thus expansion of the graphite when the expandable graphite is subjected to sufficient heat. So far as is known, expandable graphite has not been used in foams to enhance or improve thermal conductivity.

The chemicals used in the production of expandable graphite adversely affect polyurethane foam production. Some common effects include softening of the foam due to hydrolysis, severe tightening of the foam causing shrinkage, and oxidation or scorch due to the presence of acid in the expandable graphite. Untreated natural graphene and graphite do not produce the problems of expandable graphite when incorporated into polyurethane foam. The addition of natural graphite to flexible foam does not significantly alter flammability properties, and it is not a substitute for expandable graphite. Adding expandable graphite to flexible foam does not significantly alter the thermal conductivity properties, and it is not a substitute for natural graphite or graphene to improve the thermal conductivity of foam. The application of graphite or graphene in polyurethane foam described herein is thus a novel combination of materials in the field.

The TC Foam may contain graphite material in the range of about 0.1% independently to about 75% by weight based on the final net weight of the foam after gas loss. In one non-limiting embodiment the TC Foam may contain graphite material in the range of about 3% independently to about 75% by weight, and alternatively in the range of from about 5% independently to about 60% by weight, and another non-restrictive version in the range of from about 7% independently to about 40%.

The thermal conductivity of natural graphite is highly anisotropic. The thermal conductivities in the directions perpendicular and parallel to the graphene layers are 3-10 W/m ° K. and 140-500 W/m ° K., respectively. The thermal conductivity of polyurethane foam is isotropic with thermal conductivities in all directions of about 0.035-0.06 W/(m K).

The graphite material to be used in the compositions and methods herein should be selected from a list of the following, non-limiting, functional materials: natural flake graphite, powder graphite, graphene sheets, graphene, synthetic graphite, graphite-based particulates, and combinations thereof.

The graphite material may have an average particle size ranging from about 0.1 independently to about 3000 microns; alternatively, the graphite material may have a size ranging from about 1 independently to about 500 microns. The word “independently” as used herein with respect to the range for a parameter means that any lower threshold and any upper threshold for any range may be recombined to give a suitable alternative range for that parameter. As defined herein, “average particle size” may be defined as any one of median size or geometric mean size or average size, based on volume. In another non-limiting embodiment, graphene may be present on a nanometer scale, defined as 1,000 nm or less.

The TC Foam may also contain useful amounts of conventionally employed additives (“property-enhancing additives”) such as stabilizers, antioxidants, antistatic agents, antimicrobial agents, ultraviolet stabilizers, phase change materials, surface tension modifiers such as silicone surfactants, emulsifying agents, and/or other surfactants, solid flame retardants, liquid flame retardants, grafting polyols, compatible hydroxyl-containing chemicals which are completely saturated or unsaturated in one or more sites, solid or liquid fillers, anti-blocking agents, colorants such as inorganic pigments, carbon black, organic colorants or dyes, reactive organic colorants or dyes, heat-responsive colorants, heat-responsive pigments, heat-responsive dyes, pH-responsive colorants, pH-responsive pigments, pH-responsive dyes and combinations thereof, fragrances, and viscosity-modifiers such as fumed silica and clays, plasticized or un-plasticized tri-block copolymer gels and polymers, and other polymers in minor amounts and the like to an extent not affecting or substantially decreasing the desired properties of the TC Foam.

Addition of phase change materials to the TC Foam allows the construction composite to store or release energy, which is higher than heat absorbed or released by heat capacity of the non-thermally enhanced construction. Heat is stored if the solid phase change material changes to a liquid, and heat is released when the liquid phase change material changes to a solid. The melting point temperature is usually chosen to be in the 20° C. independently to 35° C. range to match the human comfort zone. Once the solid phase change material melts completely, all of the latent heat is used, and the phase change material must be cooled below its melting point to solidify the phase change material and regenerate for the next melt cycle. Suitable phase change materials have a solid/liquid phase transition temperature from −10° F. independently to 220° F. (about −23° C. independently to about 104° C.). In another non-limiting version, the phase change solid/liquid phase transition temperature is from 68° F. independently to 95° F. (about 20° C. independently to about 35° C.).

TC Foams may be prepared by a method or methods including batch-wise or continuous pouring in a form, mold or on a bun production line, and the graphite may be incorporated or blended into the polyol blend in a batch-wise or continuous process in a blending system such as a continuous stirred tank, static mixing elements, air mixers, or any other equipment known in the skill of the art that is used for mixing solids and additives with liquids.

Alternatively, graphite may be mixed in a minor polyurethane reactant stream, such as silicone surfactant, and added directly to the mix-head or manifold. The mixture flows into an open box, on a moving conveyor or into a mold, and a flexible polyurethane foam is produced which incorporates the graphite particles

The TC Foam-forming components or ingredients may be poured in a standard bun form on a conveyor, poured in a mold having planar or non-planar surfaces, texturing, 2D and 3D modification, or poured in a mold with rods to make the foam perforated.

In one embodiment, one or more TC Foams may be added within or on the surface or in any location within the interior cavity of a mold for making molded products such as, but not limited to, pillows, mattresses, or mattress topper pads, and individual substrate components added to the mold to react, bind, or encapsulate the TC Foam.

There may also be provided a flexible cellular foam comprising cross-linked latex foam and graphite dispersed in the cross-linked latex foam. The graphite may be added in the range of about 0.1 to about 75% by weight of final net weight of cured latex foam. One process used for open cell, flexible latex foam production involves adding the graphite particles to the natural or synthetic latex liquid polymer, followed by introducing air into the latex, e.g. whipping or beating warm natural or synthetic latex in the presence of additives to promote open cell formation, stabilization and curing. Additives may include, but not necessarily be limited to, foam stabilizers, foam promoters, zinc oxide delayed action gelling agents, and combinations thereof. A final step in this process is to cure the foam with heat. Suitable latex foam production processes known by those skilled in the art for latex foam manufacturing include, but are not necessarily limited to, molded and free-rise latex methods produced with the Dunlop or Talalay latex processes. In the Talalay latex process, the latex foam is cured by introducing carbon dioxide into the mold with latex. The carbon dioxide reacts with water forming carbonic acid, which lowers the pH and causes the latex to thicken and hold its cell structure and shape. The mold temperature is then raised to about 230° F. (110° C.) and held for a determined amount of time to crosslink or vulcanize the latex polymer. In the Dunlop process, the latex mixture is cured by addition of chemical additives such as sodium fluorosilicate, and later the latex is vulcanized or cross-linked by raising the temperature.

There may also be provided a flexible cellular foam comprising cross-linked melamine foam and graphite dispersed in the cross-linked melamine foam. The graphite may be added in the range of about 0.1 to about 75% by weight of final net weight of cured melamine foam

It will be appreciated that the methods described herein are not limited to these examples, since there are many possible combinations for making TC Foams with open-celled or close-celled foams that can be used in cushion foams or mattresses.

### Applications of the TC Foam

TC Foam can be manufactured and combined with substrate foams for use in a variety of bedding applications, such as, but not limited to, mattresses, pillows, mattress topper pads, pillow toppers, quilted toppers, body support foam, or other common bedding materials where a cooler feeling foam is desirable.

Layering substrates in combination with one or more TC Foams and optional property-enhancing materials described herein may find utility in a very wide variety of applications. More specifically, in other non-limiting embodiments, the combination of TC Foam and substrate would be suitable as mattress components, pillows or pillow components, including, but not necessarily limited to, pillow wraps or shells, pillow cores, pillow toppers, medical comfort pads, medical mattresses and similar comfort and support products, and residential/consumer mattresses mattress toppers, and similar comfort and support products, typically produced with conventional flexible polyurethane foam or fiber. All of these uses and applications are defined herein as “bedding products”.

FIG. 1 depicts a heat source, such as a body mass, which is introducing thermal energy into the standard, open cell viscoelastic foam layer 2 through conduction. This figure schematically illustrates a body lying on a mattress. The TC Foam 5 draws heat in and uses enhanced thermal conductivity properties to move heat laterally through the mattress. In turn, heat is conducted and convected through open air cells up through layer 2 to the top of the mattress. At this point, natural convection works to remove heat from the system. In this example, the viscoelastic layer 2 and TC Foam 5 are constructed upon another viscoelastic layer 2 and a foundation of base prime foam 1. As used herein, “prime foam” is defined as open cell polyether polyurethane commodity flexible foam commonly used in furniture and bedding applications.

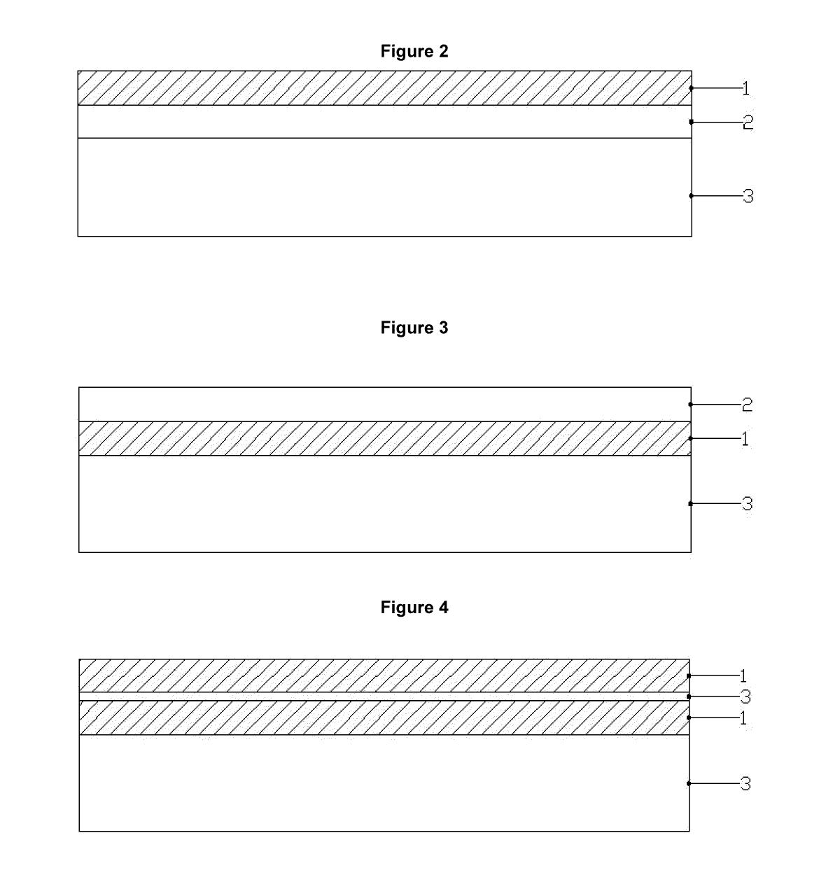

FIG. 2 is an example of construction using a cushion and/or mattress application. The base of the section is a prime foam layer 3. On top of this is a 2 inch (5 cm) standard, open cell viscoelastic (visco) layer 2. The top layer 1 is a 2 inch (5 cm) layer of TC Foam. It will be appreciated that the dimensions given in the examples and descriptions of the various Figures are merely illustrative and are not intended to be limiting.

FIG. 3 is an example construction using a cushion and/or mattress application. The base of the section is a prime foam layer 3. On top of this is a 2 inch (5 cm) layer of TC Foam 1 followed by a 2 inch (5 cm) layer 2 of standard, open cell viscoelastic foam.

FIG. 4 is an example construction using a cushion and/or mattress application. The base of the section is a prime foam layer 3. On top of this is a 2 inch (5 cm) layer of TC Foam 1 followed by a 0.75 inch (1.9 cm) layer 3 of prime foam. The top layer is a second 2 inch (5 cm) layer of TC Foam 1.

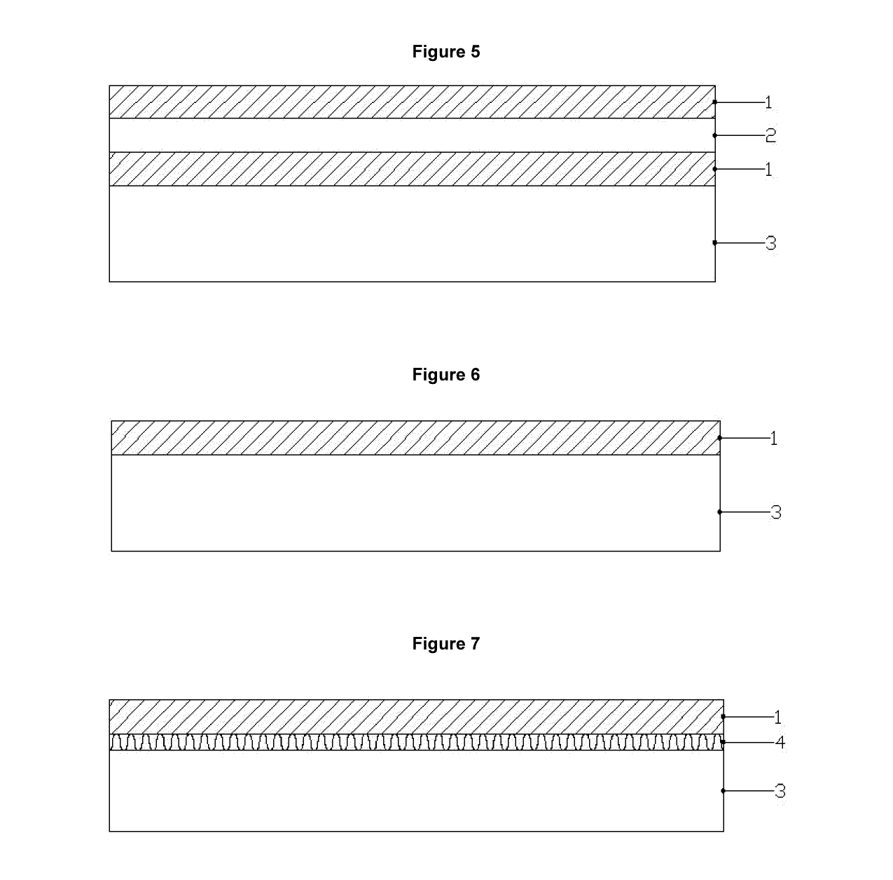

FIG. 5 is an example construction using a cushion and/or mattress application. The base of the section is a prime foam layer 3. On top of this is a 2 inch layer (5 cm) of TC Foam 1 followed by a 2 inch (5 cm) layer 2 of standard, open cell viscoelastic foam. The top layer is a second 2 inch (5 cm) layer of TC Foam 1.

FIG. 6 is an example construction using a cushion and/or mattress application. The base of the section is a prime foam layer 3. On top of this is a 3 inch (7.6 cm) layer of TC Foam 1.

FIG. 7 is an example construction using a cushion and/or mattress application. The base of the section is a prime foam layer 3. On top of this is a 3 inch (7.6 cm) layer of TC Foam 1. The interface 4 between the two layers is a non-planar convolution, which may be made by convoluting the surface of either or both interfacing layers.

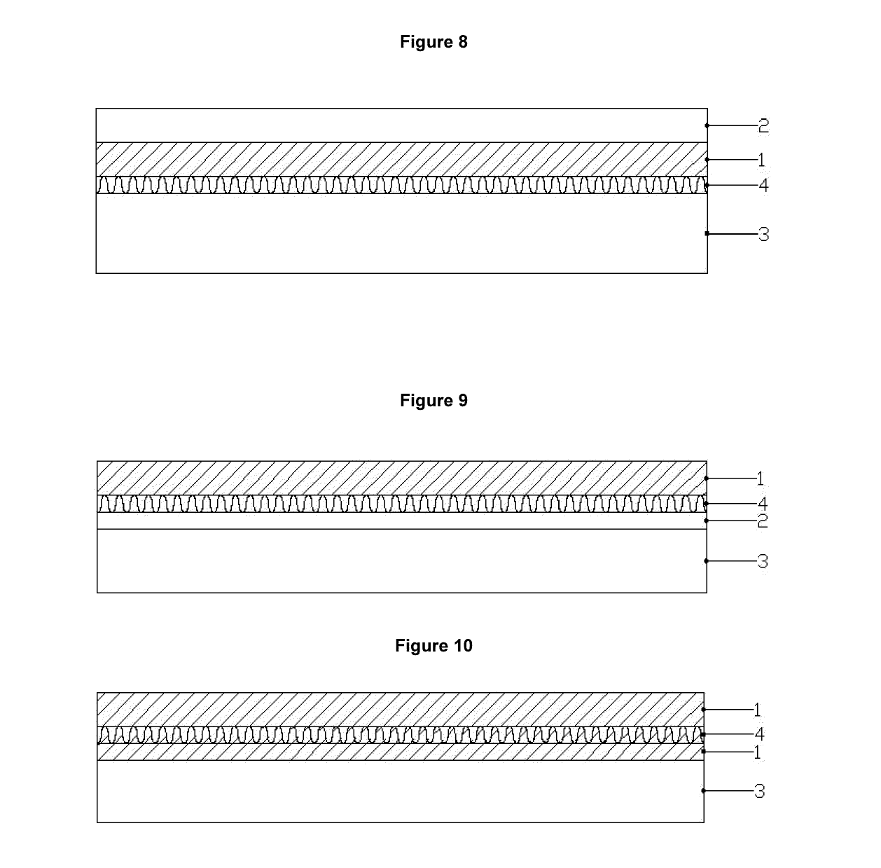

FIG. 8 is an example construction using a cushion and/or mattress application. The base of the section is a prime foam layer 3. On top of this is a 2 inch (5 cm) layer of TC Foam 1. The interface 4 between the two layers is a non-planar convolution, which may be made by convoluting the surface of either or both interfacing layers. The top of this example is a 2 inch (5 cm) layer 2 of standard, open-cell viscoelastic foam.

FIG. 9 is an example construction using a cushion and/or mattress application. The base of the section is a prime foam layer 3. Above this is a 2 inch (5 cm) layer 2 of standard, open-cell viscoelastic foam. On top of this is a TC Foam 1. The interface 4 between the two layers is a non-planar convolution, which may be made by convoluting the surface of either or both interfacing layers.

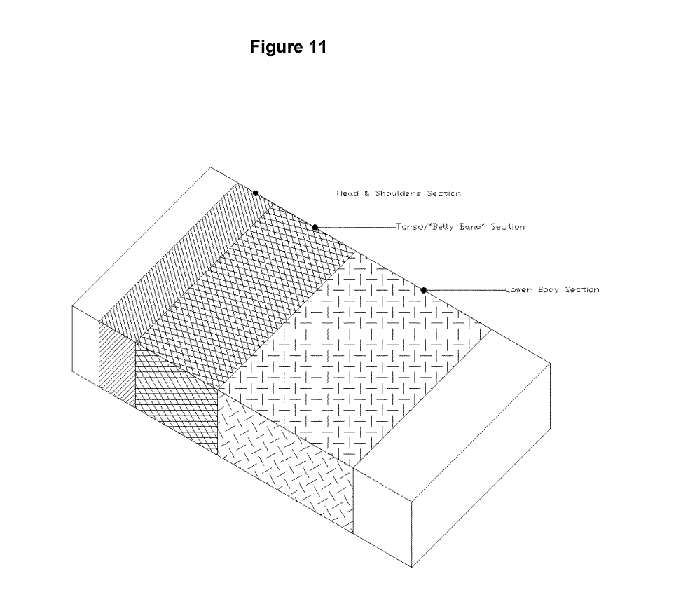

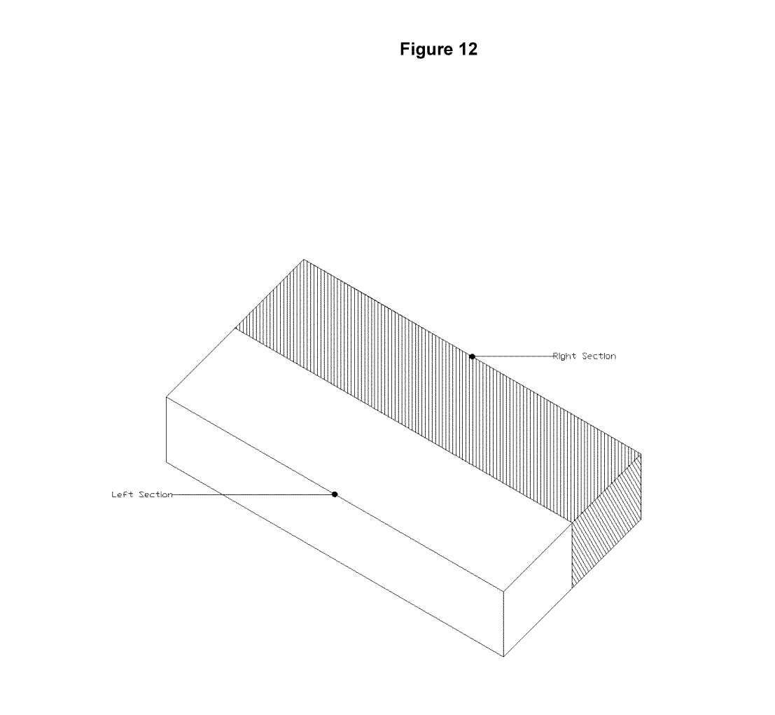

FIG. 10 is an example construction using a cushion and/or mattress application. The base of the section is a prime foam layer 3. Above this is a 2 inch (5 cm) layer of TC Foam 1. On top of this is another 2 inch (5 cm) layer of TC Foam 1. The interface 4 between the two layers is a non-planar convolution, which may be made by convoluting the surface of either or both interfacing layers.

FIG. 11 is an example breakdown of lateral mattress zones. These zones include: lower body, torso/“belly band”, and head and shoulders. These zones may or may not include TC Foams, example constructions, other mattress layer constructions, or any variation thereof. Furthermore, the zones shown are not limiting, but are used as examples to show the possibility of utilizing enhanced thermally dissipating layers in specific areas of cushions and/or a mattress.

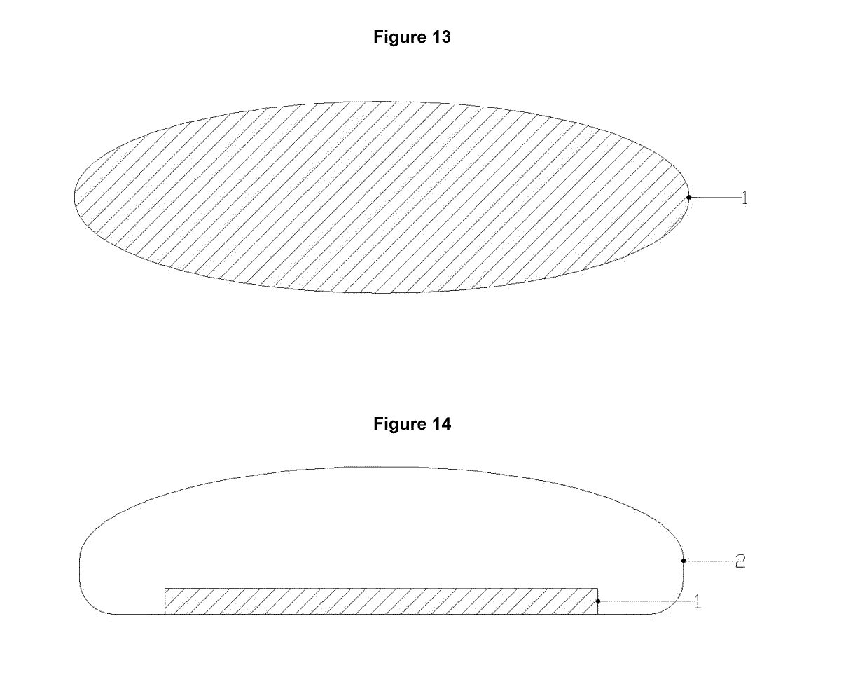

FIG. 12 is an example breakdown of longitudinal mattress zones. These zones include left or right sections. These zones may or may not include TC Foams, example constructions, other mattress layer constructions, or any variation thereof. Furthermore, the zones shown are not limiting, but are used as examples to show the possibility of utilizing enhanced thermally dissipating layers in specific areas of cushions and/or a mattress.

FIGS. 11 and 12 are meant to illustrate the usage of TC Foams in different regions of the mattress to enhance thermal conductivity in specific regions. They are not to be interpreted as limiting design figures. The exact configuration of these zoned TC Foams would be dependent on the purpose of the mattress construction.

FIGS. 13 and 14 are depictions of molded pillow systems. FIG. 13 is a pillow molded entirely out of TC Foam 1. FIG. 14 shows a pillow using TC Foam 1 as a region within the overall pillow structure 2. In these figures, any of the example constructions, or other variations, may be used. The exact configuration is dependent on the purpose of the pillow application.

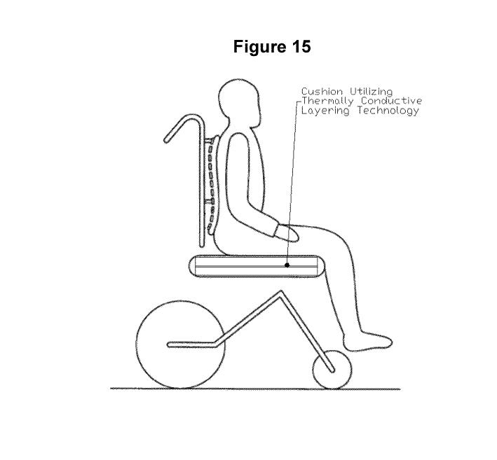

FIG. 15 depicts a wheelchair seat cushion comprising of one or more TC foam layers. In this figure, any of the example constructions, or other variations, may be used in the cushion of a wheelchair.

The invention will now be described more specifically with respect to particular formulations, methods and compositions herein to further illustrate the invention, but which examples are not intended to limit the methods and compositions herein in any way.

### EXAMPLE I

Graphite TC Foam. A two component system was obtained from Peterson Chemical Technology. The system consisted of a “B” side (PCT-8205B) containing polyols, surfactants, blowing and gelation catalysts and water, and the “A” side (PCT-8205A) consisted of an isocyanate compound. A pre-blend was made by combining 100 parts of the “B” side with 10 parts of HC-95, a graphite additive obtained from Peterson Chemical Technology, in a 32 oz. (0.95 L) mix cup. The components were mixed for approximately 45 seconds before adding 43.21 parts of the “A” side component, mixed an additional 10 seconds and poured into a 9″×9″ (23 cm×23 cm) cake box and allowed to rise and cure in a room temperature environment. This produced a foam block with a random dispersion of graphite material throughout the foam structure. It will be appreciated that the graphite material may be randomly or uniformly dispersed in the TC Foams described herein. Physical properties such as density, IFD, and airflow were measured. Additionally, measurements of the static thermal conductivity were obtained by following ASTM E1225 standards.

A second foam block was produced by an identical procedure but with the omission of the 10 parts of HC-95. This foam was tested by the same procedures and used as a comparative control for the TC Foam.

### Discussion of Results

Table 1 shows the formula and test results for the two foams produced by following the procedure of Example I. The results indicate an increase in the thermal conductivity (Static TC) of the control foam by 50.5%, from 0.0507 W/(m K) to 0.0763 W/(m K). Density was slightly increased (6.1%) as would be expected from the addition of solids (7.0% by weight based on the final foam net weight after gas loss). There was only a slight loss in IFD (12.1%), and there was no significant difference in the airflow (4.7%) between the control and the experimental TC Foam.

TABLE 1
Comparison of formula and properties of control and TC Foams

| | Measure | Control | TC Foam |
|---|---|---|---|
| Material | | | |
| “B” Side | parts by weight | 100 | 100 |
| “A” Side | parts by weight | 43.21 | 43.21 |
| HC-95 | parts by weight | 0 | 10 |
| Gross Parts | parts by weight | 143.21 | 153.21 |
| Gas Loss | parts by weight | 10.35 | 10.35 |
| Net Parts | parts by weight | | 142.86 |
| Property | | | |
| Density | lbs/ft³ (kg/m³) | 3.45 (55.2) | 3.66 (58.6) |
| IFD | lbs/50 in² (N/323 cm²) | 9.1 (40.5) | 8.0 (35.6) |
| Airflow | SCFM | 4.94 | 5.17 |
| Static TC | W/(m-°K) | 0.0507 | 0.0763 |

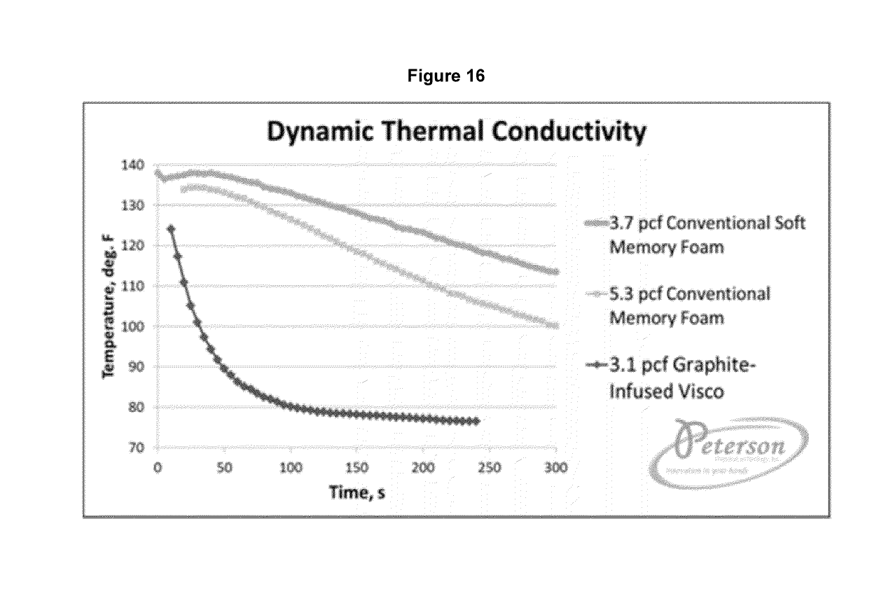

Shown in FIG. 16 is a graph of thermal conductivity expressed as temperature over time for 3.1 pcf graphite-infused viscoelastic foam compared to 1.7 pcf conventional soft memory foam and 5.3 pcf conventional memory foam. It may be seen that the graphite-infused viscoelastic foam offers greatly improved thermal conductivity by combining open-cell high air-flow visco with highly conductive graphite. The unique open cell polymer structure enhances air flow by 95% to produce breathable and odorless foam with superior convective heat flow. The incorporation of highly heat conductive graphite, a material that has up to ten thousand times better thermal conductivity compared to foam, dramatically enhances the thermal conductivity of viscoelastic foam.

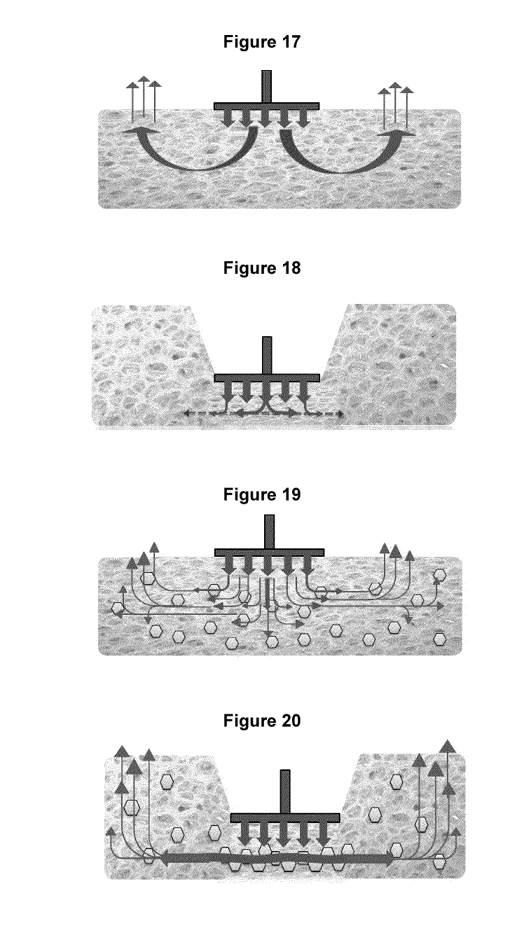

Shown in FIG. 17 is a schematic illustration of uncompressed viscoelastic (visco) foam which depicts that heat flow depends on open cells to leave the foam through convection. FIG. 18 shows a schematic illustration of compressed visco foam depicting that compression (such as when a person lies on a visco mattress) closes the foam cells thereby hindering air flow and not allowing heat to escape. FIG. 19 is a schematic illustration of uncompressed, graphite-infused visco foam depicting that heat is rapidly dissipated through open cells of the visco and the highly conductive graphite material, schematically illustrated by the spheres. Further, FIG. 20 is a schematic illustration of compressed, graphite-infused visco foam schematically depicting that compression forces the graphite particles or material together, touching or in close proximity, providing a highly conductive pathway for heat to move toward uncompressed adjacent foam where heat may be liberated by convection.

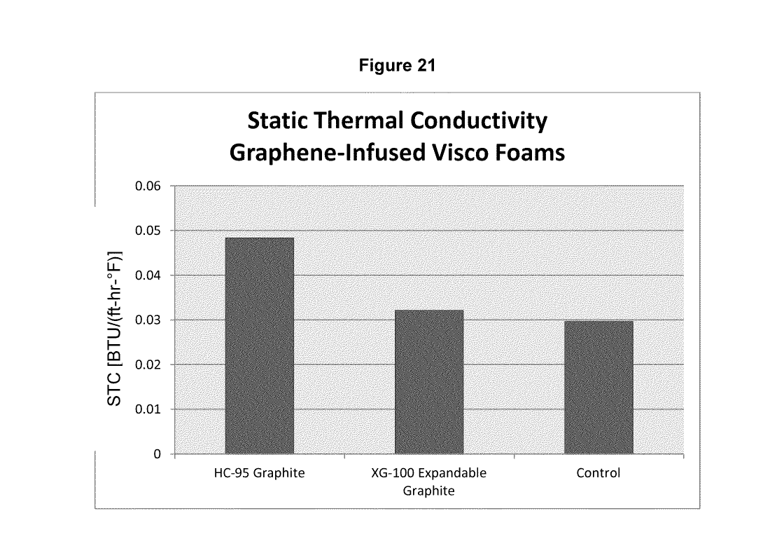

Table 2 presents data comparing the thermal conductivity of graphite-infused foam and expandable graphite foam to a control. It may be seen that the graphite flake improves thermal conductivity to a much greater degree than expandable graphite. The Static Thermal Conductivity (STC) results are plotted in FIG. 21.

TABLE 2
Graphite-Infused Visco StaticTC Study

| | | | XG-100 | |
|---|---|---|---|---|
| | | | Expandable | |
| | | HC-95 Graphite | Graphite | Control |
| Polyol System MS-3506 | | 100 | 100 | 100 |
| MDI, pph | | 43.15 | 43.25 | 43.25 |
| Additive: | type | HC-95 | XG-100 | XG-100 |
| | amount | 15 | 15 | 15 |

| | | | |
|---|---|---|---|
| Density | 4.04 | 4.24 | 4.02 |
| Air Flow | 3.47 | 3.58 | 3.56 |
| Crushed Air Flow | 5.06 | 5.04 | 5.04 |
| SCT [BTU/(ft-hr-° F.) | | | |
| SCT Increase v. Control | 63.2% | 8.4% | |

HG-95 Graphite Flake is available from Peterson Chemical Technology, Inc.
XG-100 Expandable Graphite is available from Peterson Chemical Technology, Inc.
Polyol System MS-3506 is available from Peterson Chemical Technology, Inc.

Many modifications may be made in the methods of and implementation of this invention without departing from the spirit and scope thereof that are defined only in the appended claims. Various combinations of graphite materials, polyols, isocyanates, catalysts and additives, and processing conditions other than those explicitly described herein are expected to be useful.

The words “comprising” and “comprises” as used throughout the claims is interpreted “including but not limited to”. The present invention may suitably comprise, consist or consist essentially of the elements disclosed and may be practiced in the absence of an element not disclosed.

For instance, there may be provided a thermally-conductive foam (TC Foam) consisting essentially of or consisting of flexible cellular foam, and graphite material dispersed in the flexible cellular foam, where the graphite material is selected from a group consisting of natural flake graphite, powder graphite, graphene sheets, graphene, synthetic graphite, graphite-based particulates, and combinations thereof.

What is claimed is:

1. A thermally conductive foam (TC Foam) comprising:
flexible cellular foam, and
graphite material dispersed in the flexible cellular foam, where the graphite material is selected from a group consisting of natural flake graphite, powder graphite, graphene sheets, graphene, synthetic graphite, graphite-based particulates, and combinations thereof.

2. The TC Foam of claim 1 where the flexible cellular foam is produced by a process comprising polymerizing a polyol with an isocyanate.

3. The TC Foam of claim 1 where the TC Foam is produced by a method comprising:
introducing graphite material into a mixture of flexible cellular foam-forming components comprising a polyol and an isocyanate; and
polymerizing the polyol and the isocyanate to form the flexible cellular foam.

4. The TC Foam of claim 1 where the flexible cellular foam is selected from the group consisting of an open-celled polyurethane foam, partially open-celled polyurethane foam, open-celled polyester polyurethane foam, partially open-celled polyester polyurethane foam, and combinations thereof.

5. The TC Foam of claim 1 wherein the TC Foam comprises graphite material in the range of about 0.1 to about 75% by weight based on the final foam net weight after gas loss.

6. The TC Foam of claim 1 wherein the TC Foam comprises graphite material in the range of about 3 to about 75% by weight based on the final foam net weight after gas loss.

7. The TC Foam of claim 1 wherein the TC Foam comprises graphite material in the range of about 5 to about 60% by weight based on the final foam net weight after gas loss.

8. The TC Foam of claim 1 wherein the graphite material has an average particle size ranging from about 1 to about 3000 microns.

9. The TC Foam of claim 1 wherein the TC Foam comprises a structure selected from the group consisting of a solid sheet, perforated sheet, non-planar sheet, planar sheet, textured sheet, and combinations thereof.

10. The TC Foam of claim 1 further comprising a layering substrate adhered to the TC Foam.

11. An article of manufacture selected from the group consisting of a cushion foam, a mattress, a mattress topper pad, and combinations thereof, where the article of manufacture comprises at least one zone selected from the group consisting of a longitudinal zone, a lateral zone, and combinations thereof, where the at least one zone comprises the TC Foam of claim 1.

12. An article of manufacture selected from the group consisting of medical cushioning foams, mattresses, pillows, bedding products, mattress pillow toppers, quilted mattress toppers, mattress topper pads, indoor cushioning foams, outdoor cushioning foams, outdoor bedding pads, outdoor pillows, and combinations thereof, where the article of manufacture further comprises at least one layer comprising the TC Foam of claim 1.

13. A cushion foam comprising at least one layer comprised of the TC Foam of claim 1.

14. A mattress comprising at least one layer comprised of the TC Foam of claim 1.

15. A mattress topper pad comprising at least one layer comprised of the TC Foam of claim 1.

16. A pillow comprising the TC Foam of claim 1.

17. An article of manufacture comprising at least one layer comprised of the TC Foam of claim 1 and produced by a method selected from the group consisting of molding, free-rise, and combinations thereof, where the article is selected from the group consisting of a seat cushion, back support and combination thereof.

18. An article of manufacture comprising at least one layer comprised of the TC Foam of claim 1 and produced by a method selected from the group consisting of molding, free-rise layer and combinations thereof, where the article is selected from the group consisting of a seat cushion, back support and combinations thereof that has temperature adjustment selected from the group consisting of active heating, active cooling and combinations thereof accomplished by a mechanism selected from the group consisting of electrical resistance, solar heating, refrigerant, evaporative cooling, heat exchanger and combinations thereof.

19. A thermally conductive foam (TC Foam) comprising:
a cured latex foam, and
graphite material dispersed in the flexible cellular foam, where the graphite material is selected from a group consisting of natural flake graphite, powder graphite, graphene sheets, graphene, synthetic graphite, graphite-based particulates, and combinations thereof.

20. The TC Foam of claim 19 wherein the TC Foam comprises graphite material in the range of about 0.1 to about 75% by weight based on the final net weight of cured latex foam.

21. An article of manufacture selected from the group consisting of medical cushioning foams, mattresses, pillows, bedding products, mattress pillow toppers, quilted mattress toppers, mattress topper pads, indoor cushioning foams, outdoor cushioning foams, outdoor bedding pads, outdoor pillows, and combinations thereof, where the article of manufacture further comprises at least one layer comprising the TC Foam of claim 19.

22. A thermally conductive foam (TC Foam) comprising:
a cured melamine foam, and
graphite material dispersed in the flexible cellular foam, where the graphite material is selected from a group consisting of natural flake graphite, powder graphite, graphene sheets, graphene, synthetic graphite, graphite-based particulates, and combinations thereof

23. The TC Foam of claim 22 wherein the TC Foam comprises graphite material in the range of 0.1 to 75% by weight based on the final net weight of cured melamine foam.

24. An article of manufacture selected from the group consisting of medical cushioning foams, mattresses, pillows, bedding products, mattress pillow toppers, quilted mattress toppers, mattress topper pads, indoor cushioning foams, outdoor cushioning foams, outdoor bedding pads, outdoor pillows, and combinations thereof, where the article of manufacture further comprises at least one layer comprising the TC Foam of claim 22.
